(19) United States
(12) Patent Application Publication
(10) Pub. No.: US 2010/0207286 A1
(43) Pub. Date: Aug. 19, 2010

(54) HUMIDIFIER WITH ADJUSTABLE AIR FLOW

(76) Inventor: Donald N. Jursich, Crystal Lake, IL (US)

Correspondence Address: GREER, BURNS & CRAIN, 300 S WACKER DR, 25TH FLOOR, CHICAGO, IL, 60606, US

(21) Appl. No.: 12/388,206

(22) Filed: Feb. 18, 2009

(51) Int. Cl. B01F 3/04

(52) U.S. Cl. 261/102; 261/103; 261/105; 261/106; 261/DIG. 15

(57) ABSTRACT

A humidification system includes a humidifier housing mountable to the air duct. The humidifier housing has an opening to provide fluid communications between the humidifier housing and the air circulation system. An air inlet extends through the duct opening into the humidifier housing. A duct damper extends into the air duct and is reversibly positionable between a stowed position and a deployed position. The stowed position is characterized by placement of the duct damper substantially adjacent to the humidifier housing while the deployed position is characterized by positioning a portion of the duct damper deeper into the air duct. An evaporative element is positioned between the air inlet and an air outlet. A cover is configured to reverse the direction of flow air sending it to the air outlet extending into the air duct. A deploying means changes the duct damper between the stowed position and the deployed position.

### FIELD OF THE INVENTION

The present invention relates to humidifiers, particularly humidifiers for hot air furnaces and heating systems. More specifically, the instant humidifier allows the volume of air flowing through the humidifier to be adjusted.

### BACKGROUND OF THE INVENTION

Humidifiers for hot air furnaces and space heating systems are typically comprised of a housing having an air inlet and an humidification system for passing space heating air from the furnace through the housing and over and/or through a water fed evaporator in the housing for moistening the heating air passing through the housing and to the space heating system. The structure, mode of operation and beneficial effects of hot air furnace humidifiers are well known.

A typical bypass humidifier to be used in association with a hot air furnace includes warm or hot air supply ducting, cool or cold air return ducting and an internal blower for forcing heated air from the furnace through the ducting. The humidified air is forced to a space to be heated. Cool air from the space is pulled or drawn through the ducting back to the furnace to be reheated and re-circulated through the space. A bypass humidifier has an inlet in its back wall connected in fluid communication with one or the other of the ducts, usually the hot air supply ducting, and an outlet connected in fluid (gaseous) communication with the other of the ducts, usually the cool air return ducting. Due to the differential between the relatively higher pressure airflow in the supply ducting and the relatively lower pressure airflow in the ducting, air is induced to flow from the supply ducting through the humidifier to the return ducting, thereby causing air to flow over and/or through an evaporator unit in the housing to moisturize, i.e., humidify, the air flowing through the space heating system. A damper installed at the outlet of the humidifier controls the amount of air passing through the humidifier and thus the amount of moisturized air delivered to the space to be heated.

U.S. Pat. No. 5,368,784 suggests a method of improving air flow through the humidification system by placing a scoop inside the air duct so that pressure from the flowing air can be harnessed to push dry air through the humidifier. Air is forced into the humidification system, through an evaporative element, then turned 180° to exit back through the evaporative element and exits via an outlet back into the air duct. This improvement provides continuous humidification and requires only a single opening in the air duct for installation.

A disadvantage of this humidifier is that there is no way to change the amount of air that enters the humidifier for use with a variety of furnaces, ducts and conditions. During extreme cold, the air is very dry. The thermostat may call for the furnace to turn off before the air is humidified to the desired extent. In such a case, it would be desirable to be able to divert more air through the humidifier to reduce dryness.

Other fixed duct scoops are known having multiple louvers that extend into the air duct. However, any fixed scoop has the disadvantage of always diverting the same amount of air into the humidifier, regardless of how much air is needed to provide the appropriate quantity of humidified air. Constant diversion of the air through the evaporative element utilizes energy by the fan to force the air through the humidifier even when it is not needed. When it is especially dry, no additional air can be sent to the evaporative element to provide higher average moisture content. Thus, energy could be reduced or the range of humidification could be extended by utilizing a mechanism that varies the amount of air that is diverted through the humidifier.

### SUMMARY OF THE INVENTION

An air humidification system is designed for use with a forced air circulation system having an air duct with air circulating therein. The humidification system includes a humidifier housing mountable to the air duct. The humidifier housing has an opening adapted to be aligned with a duct opening to provide fluid communications between the humidifier housing and the air circulation system. An air inlet extends into the air duct for directing unhumidified air from the air duct through the duct opening into the humidifier housing. A duct damper also extends into the air duct and is reversibly positionable between a stowed position and a deployed position. The stowed position is characterized by placement of the duct damper substantially adjacent to the humidifier housing while the deployed position is characterized by positioning a portion of the duct damper deeper into the air duct to increase in air flow into the air inlet compared to when the duct damper is in the stowed position. An evaporative element is positioned between the air inlet and an air outlet and configured to provide water in the path of the unhumidified air to convert it to humidified air. A cover is configured to reverse the direction of flow of the humidified air sending it to the air outlet extending into the air duct for directing flow from the humidifier housing into the air duct. A deploying means changes the duct damper between the stowed position and the deployed position.

The humidification system of the present invention allows the amount of air that flows through the evaporative element to vary depending on the season of the year. Reduction in size of the humidifier allows the air within the heating system to flow more freely and heat the air more effectively. Use of the duct damper forces large amounts of air through the humidifier only when it is necessary and can result in energy savings.

### DETAILED DESCRIPTION OF THE DRAWINGS

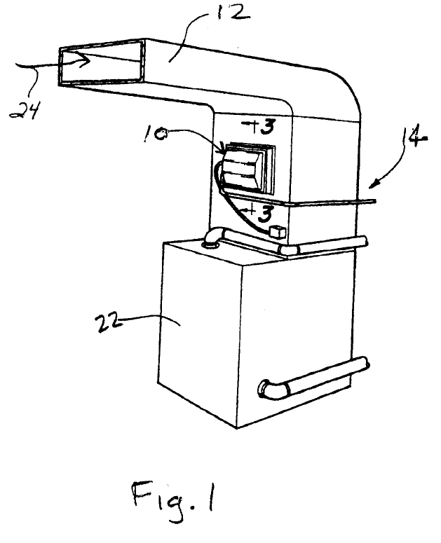

FIG. 1 is a an elevated perspective drawing of the humidification system of the present invention installed for use on a forced air furnace;

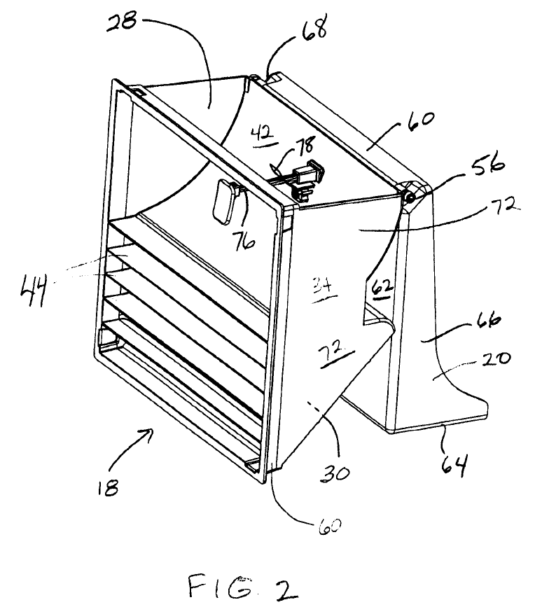

FIG. 2 is an elevated perspective view of the air handling system of the present invention with the damper in the stowed position; and

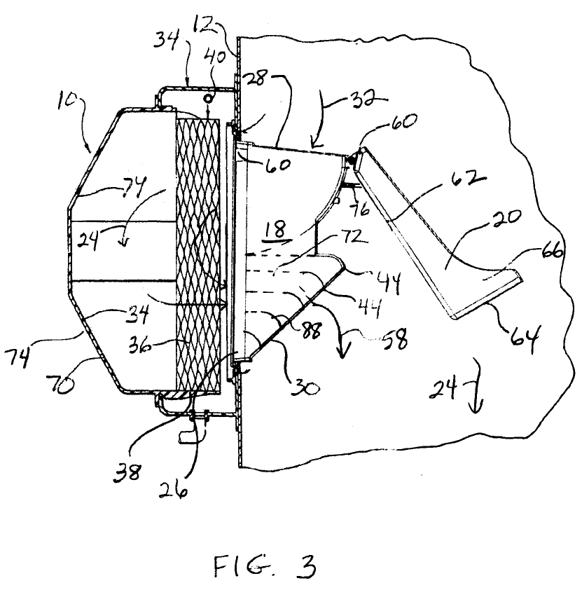

FIG. 3 is a side cutaway view of the air duct of FIG. 1, showing the humidification system in the duct with the damper in the deployed position.

### DETAILED DESCRIPTION OF THE INVENTION

Referring to FIG. 1, a humidification system, generally 10, is shown installed into an air duct 12 of a heating system, generally 14, of a building (not shown). The heating system 14 includes a fan (not shown) and a furnace 22 for heating circulating air. Although this humidification system 10 could be used with an air conditioning system, it is generally not needed because warm outdoor air that is available during the cooling season holds more moisture than cold outdoor air available during the heating season.

It is envisioned that the present humidification system 10 could be used with any heating system 14 that benefits from humidification of air 24 flowing through it, and wherein a pressure differential exists in the air duct 12 that is usable to divert unhumidified air 32 through the humidification system 10. The pressure differential must be sufficient to push a reasonable amount of unhumidified air 32 through the humidification system 10 for the intended purpose. A duct damper 20 is used to modify the amount of unhumidified air 32 that is diverted through the humidification system 10. The description that follows an exemplary humidification system 10 is described as being used with a forced air furnace 22, but is not intended to be limited to that application. Further, directional references made in the discussion that follows are to be interpreted as if the humidification system 10 is oriented as shown in FIG. 2.

The humidification system 10 includes an air handling system, generally 18, a humidifier housing, generally 34, an evaporative element 36, a pad frame 38, and a means of controlling humidity output 40. The air handling system 18 includes an air inlet 28, an air outlet 30 having a plurality of louvers 44 and the duct damper 20 (FIG. 2). With the exception of the evaporative element 36 described below, any material can be used to manufacture these parts as long as it does not rust and is strong enough to hold its shape under the pressure and flow of the air in the forced air system. Typical materials include metals, such as aluminum, plastics including thermoplastics or plastic coated materials. Materials that are good choices for this application will not absorb or retain water that can breed molds or bacteria. At least one embodiment of this invention uses thermoplastic materials for the manufacture of the humidification system 10.

Referring to FIG. 1, the humidification system 10 is mountable to a surface of the air duct 12. In the example discussed below, the housing 34 is attachable to the air duct 12 where there is sufficient pressure to push air through the humidification system 10. In a forced air furnace 22, the pressure is highest just downstream of the furnace fan. Other placement arrangements that will be obvious to an artisan are contemplated for use with this invention.

In at least one embodiment, the humidification system 10 is mountable to the furnace 22 air duct or plenum 12. In order to mount the humidification system 10 it is necessary to cut a duct opening 26 in the air duct 12. A base frame 60 is the portion of the housing that attaches the humidification system 10 to the air duct 12 and defines the duct opening 26. The duct opening 26 should be cut into the duct approximately the same size and shape as the base frame 60 to minimize leakage of air where the air duct and the base frame meet. The base frame 60 is then mounted to the air duct 12 and secured thereto with fasteners (not shown), such as sheet metal screws. A square or round duct opening 26 is used in at least some embodiments to facilitate use of the humidification system 10 with either horizontal or vertical flow furnaces.

Parts of the housing 34 include the base frame 60, a cover 70 and at least one side panel 72. The base frame 60 mounts to the duct opening 26 in the air duct 12 as discussed above. The cover 70 is attachable to the base frame 60 by any means of removably attaching it. Examples of means of removably attaching the cover is by use of removable fasteners, a ridge and groove (not shown) to attain a snap fit, friction fit or a hinge and latch. Various fastening methods can also be used together, such as using a snap fit to hold parts in place then using auxiliary fasteners for strength.

The shape of the cover 70 should be such that, after flowing through the evaporative element 36, the direction of the humidified air is reversed back through the evaporative element 36 to the air outlet 30. Some embodiments of the cover 70 are configured with a semi-circular shape to minimize dead spots, directing the air around and out through the evaporative element 36. Multiple angled flat panels 74 are optionally be used to approximate a semi-circular shape. The use of additional angled panels (not shown) to better direct the air flow toward the humidification system 10 are contemplated. As it is visible from the living space in the vicinity of the furnace, the cover 70 optionally includes design elements (not shown) that give it a pleasing appearance.

At least one evaporative element 36 is positioned between the air inlet 28 and the air outlet 30. The pad frame 38 supports the evaporative element 36 and holds it in place. The evaporative elements 36 are well known in the art, for example slit and expanded metal pads that provides an evaporative surface for air flowing through the element. Alternative evaporative elements may be used, including wicking types. For the purposes of this application, the term “evaporative element” includes all devices for evaporating water to provide humidification. As air is directed through the evaporative element 36, water evaporates and becomes entrained in the air 24, thereby humidifying it. If more than one evaporative element 36 is present, any additional evaporative elements are also positioned to receive unhumidified air 32, not humidified air 58.

Preferably the air 24 is directed over the evaporative element 36 twice. As the warm air is contacted with the water, heat from the air 24 is used to vaporize the water. It is unlikely that the air will be saturated in a single pass through the evaporative element 36. Reversing the flow of the air 24 in the cover 70 and allowing it to pass through the evaporative element 36 a second time increases the degree of saturation compared to single-pass airflow.

The means for controlling humidity output 40 controls the delivery of water to the evaporative element 36. For example, the moisture can be controlled via a solenoid operated water valve 40, thereby to attain and maintain a predetermined degree of relative humidity in the air being conducted by the furnace fan through the space to be heated. The control circuitry (not shown) for the humidification system 10 preferably comprises a temperature sensor/transmitter unit (“thermostat”) and a humidity sensor/transmitter unit (“humidistat”) installed at an appropriate location or locations in the room or space heating and furnace system 22. Optionally contained within the housing 34 is a wireless temperature receiving unit, a wireless humidity receiving unit, a transformer, a thermister and/or any suitable switches and electrical/electronic components (not shown) for operating the solenoid valve 40. As used herein the term “means for controlling humidity output” 40 means any mechanical, electrical and/or electromechanical device or assembly for controlling humidity output of the humidifier, including but not limited to the aforesaid solenoid operated water valve 40 to selectively provide water to the evaporative element 36.

After passing through the evaporative element 36, the air is directed to the air outlet 30. The air outlet 30 extends into the air duct so that the humidified air is deposited into the stream of air flowing to the furnace. Use of the air outlet 30 also prevents humidified air from reentering the humidification system 10 where it is unlikely to pick up additional moisture. In some embodiments, the air outlet 30 includes a plurality of louvers 44.

The plurality of louvers 44 is attached to the bypass frame 22, positioned at least partially within the air outlet 30. As shown, the louvers 44 are an integral part of the air handling system 18, however attachment of individual louvers 44 is contemplated. The number of louvers 44 to be used is variable, depending on the physical size of the humidifying system 10, and the degree of humidification per pass that is desired. At least two louvers 44 are used, but the addition of more louvers 44 is contemplated. Use of the louvers 44 provides a smooth transition for the humidified air from the housing 34 to the air duct 12 with a minimum of turbulence. As the number of louvers 44 increases, the humidification increases. The number of louvers is preferably between two and ten, or even greater.

Each of the louvers 44 directs a portion of the air from the evaporative element 36 to a section of the air duct 12. In some embodiments of this invention, the depth of the louvers 44 increases progressively moving deeper into the air duct 12. More specifically, the shallowest louvers 44 are encountered by the air flow closest to the bottom of the housing 34 and the deepest louvers are utilized by the air flowing close to the center of the evaporative element 36. Although the increase in depth need not be uniform between one louver 44 and the next, it is one option in selecting the depth of the louvers. Another method of selecting the size of the louvers 44 is to choose a size which results in uniform amounts of air being directed into the various portions of the air return 46. Size and configuration of the louvers 44 may vary as long as they divert some of the air in the housing 34 back into the heating duct 12.

The louvers 44 may be any shape that directs air out of the humidifying unit 10. As shown in FIG. 3, louvers 44 preferably have a curved portion 88 are useful for smoothly redirecting the flow of humidified air. This is a simplified drawing as actual air currents will be more complex. Each louver scoops a portion of air 24 from the evaporative element 36. Then the portion of air is channeled by the curved area 88 toward the air duct 12. Each air portion is diverted to a different area of the air duct 12 and in the same direction as the duct airflow to minimize air turbulence. As shown in FIG. 2, the louvers 44 extend the entire width of the bypass frame 22, however, a louver 44 may also be used that extends into the air duct 12 over only part of its width.

As shown in FIG. 1, this humidification system 10 is oriented for use with a vertical flow furnace. Another embodiment of the invention has been modified for use with a horizontal flow furnace. The modifications include orienting the louvers 44 such that unhumidified air 32 is directed into the humidifier 10 and humidified air 58 is returned to the air duct 12. Other modifications will be known by artisans for adapting this humidification system 10 to other furnace types.

A method for humidification includes withdrawing a portion of unhumidified air 32 through an air inlet 28 from the air duct 12 using a scoop 42 and directing it to the evaporative element 36. The unhumidified air 32 then flows through the evaporative element 36 whereby it is at least partially humidified. Moisture is maintained on the evaporative element 36 by any known means. Examples of ways of maintaining moisture on the evaporative element 36 include wicking of water by the evaporative element 36, dripping or flow of water onto the evaporative element 36, preferably from above the evaporative element 36, spraying of water and dipping of at least a portion of the evaporative element 36 into water.

The humidity in the building is preferably controlled using a controlling device 40 such as a humidistat and solenoid valve. As long as the controlling device calls for additional humidity, the solenoid valve 40 remains open and moisture is maintained on the evaporative element 36. However, when the humidistat is satisfied, the solenoid valve 40 closes, stopping the flow of water. The evaporative element 36 is then allowed to become dry, no longer containing water to evaporate into the unhumidified air 32.

After passing through the evaporative element 36, the humidified air is channeled out of the evaporative element 36, the direction of the humidified air is reversed and it is returned for a second pass through the evaporative element 36. The humidified air 58 is then returned to a portion of an air duct 12 via louvers 44 in air handler 20.

The duct damper 20 is attached to the humidification system housing 34 in a manner that allows it to be positioned in a stowed position and a deployed position. In some embodiments, the damper is rotatably attached to the humidification system housing. Optionally, the duct damper 20 is able to be positioned at one or more intermediate positions between the stowed position and the deployed position. When in the stowed position, a minimum amount of air is directed through the air inlet passageway. Varying the position of the duct damper 20 changes the volume of air guided into the humidifier relative to the volume of air moving within the duct past the humidifier. In many embodiments, movement of the duct damper 20 toward the deployed position effectively extends the penetration of the inlet passageway deeper into the air duct 12. Optionally, the duct damper 20 rotates on one or more hinge 56, however other methods of varying the position of the duct damper are contemplated.

As shown in FIG. 3, one embodiment of the duct damper 20 includes a top 60 that is hingedly attached to the air handler 18 of the humidification system housing. When in the stowed position, a first side 62 is attached to the air handler top and extends toward the bottom of the louvers 44 where it is attached to a damper bottom 64. Often the first side is rectangular, but any shape is optionally used that varies the air flow through the duct as desired. The damper bottom is approximately opposite the top. In this embodiment, the damper bottom is planer and fixed normal to the first side 62. However, embodiments are contemplated whereby the bottom and first side form a single curved surface, much like the shape of the air inlet 28. Other contemplated embodiments include planer bottoms fixed to the first side 62 at obtuse or even acute angles. It is also contemplated that second 66 and third sides 68 extend from the damper bottom 64 along either side of the first side 62 to the damper top 60. The second 66 and third sides 68 reduce the amount of air 24 that flows easily around the duct damper 20 by trapping a portion of the air within the damper sides.

The presence of the duct damper 20 occupies space that would be used for air flow were the duct damper not present in the air duct 12. This increases the local air pressure, forcing more air into the air inlet 28 than if the duct damper 20 not present at all. In the stowed position, the duct damper 20 causes a minimum amount of air to be pushed through the air inlet 28. Deployment of the duct damper 20 pushes the damper bottom deeper into the air duct 12. As the damper extends into the duct 12, it blocks the flow of more air than when it is in the stowed position. Air pressure around the duct damper again increases, resulting in still more air to be pushed into the air inlet 28. When the duct damper 20 is fully deployed, a maximum amount of air 24 enters the air handler 18 for humidification.

Preferably, a deploying means 76 is added to aid in deployment of the duct damper 20. An exemplary deploying means 76 is a deployment arm that extends through the air handler 18 and attaches to the duct damper 20. The deployment arm is movable between a first position, placing the duct damper 20 in the stowed position, and a second position, converting the duct damper 20 to the deployed position. It is contemplated that the deployment arm 76 also holds the duct damper 20 in one or more intermediate positions. Optionally, a stop or locking mechanism 78 holds the deployment rod in the first position, the second position and any intermediate positions. The stop means is optionally a slot through which the deploying means 76 protrudes which produces sufficient friction to hold the deploying means 76 in position.

While a particular embodiment of the apparatus and method for humidifying air has been shown and described, it will be appreciated by those skilled in the art that changes and modifications may be made thereto without departing from the invention in its broader aspects and as set forth in the following claims.

What is claimed is:

1. An air humidification system for a forced air circulation system having an air duct with air circulating therein, said humidification system comprising:
a humidifier housing mountable to the air duct, said humidifier housing including an opening adapted to be aligned with a duct opening to provide fluid communications between said humidifier housing and the air circulation system;
an air inlet extending into the air duct for directing unhumidified air from the air duct through said duct opening into said humidifier housing;
a duct damper extending into the air duct and reversibly positionable between a stowed position and a deployed position, wherein said stowed position characterized by placement of said duct damper substantially adjacent to the humidifier housing and said deployed position being characterized by an increase in air flow into said air inlet compared to when said duct damper is in said stowed position;
an evaporative element positioned between said air inlet and an air outlet and configured to provide water in the path of the unhumidified air to convert it to humidified air;
a cover configured to reverse the direction of flow of the humidified air;
said air outlet extending into the air duct for directing flow from said humidifier housing into the air duct; and
a deploying means for changing said duct damper between said stowed position and said deployed position.

2. The humidification system of claim 1 wherein said housing is made of metal, plastic or plastic-coated materials.

3. The humidification system of claim 1 wherein said air inlet and air outlet are at least partially curved.

4. The humidification system of claim 1 wherein said deploying means comprises an arm and a lock to hold said damper in a position.

5. The humidification system of claim 1 wherein said air outlet comprises a plurality of louvers.

6. The humidification system of claim 1 wherein said evaporative element comprises a slit and expanded material.

7. The humidification system of claim 1 wherein said duct damper is positionable in any position between said stowed position and said deployed position.

8. The humidification system of claim 1 wherein said air inlet is a scoop.

9. The humidification system of claim 1 further comprising a means for controlling humidity output.

10. The humidification system of claim 1, wherein said duct damper is hingedly connected to the air inlet.
